(19) United States
(12) Patent Application Publication
(10) Pub. No.: US 2013/0208311 A1
(43) Pub. Date: Aug. 15, 2013

(54) POWER MANAGEMENT SERVER, IMAGE PROCESSING APPARATUS AND CONTROL METHOD THEREOF, POWER MANAGEMENT SYSTEM, POWER MANAGEMENT METHOD, AND NON-TRANSITORY COMPUTER-REDABLE MEDIUM

(71) Applicant: CANON KABUSHIKI KAISHA, (US)

(72) Inventor: Kensuke Hirata, Kawasaki-shi (JP)

(73) Assignee: CANON KABUSHIKI KAISHA, Tokyo (JP)

(21) Appl. No.: 13/755,981

(22) Filed: Jan. 31, 2013

(30) Foreign Application Priority Data
Feb. 15, 2012 (JP) 2012-031044

(51) Int. Cl. H04N 1/00

(52) U.S. Cl. CPC H04N 1/00888
USPC 358/1.15

(57) ABSTRACT

A power management server for managing electric power for each of groups to which a plurality of image processing apparatuses belong, comprises: a determination unit configured to, when accepting, from an image processing apparatus, a power reservation request for reserving electric power to be used, determine whether to permit power reservation for the power reservation request, in a group to which the image processing apparatus belongs, in accordance with whether a total of a power value notified by the power reservation request, a reservation power value of the group, and a present electricity consumption of the group exceeds an upper-limiting power value of the group; and a notification unit configured to notify a power reservation determination result from the determination unit as a response to the power reservation request.

### BACKGROUND OF THE INVENTION

1. Field of the Invention

The present invention relates to a power management server, an image processing apparatus and a control method thereof, a power management system, a power management method, and a non-transitory computer-readable medium. More particularly, the present invention relates to a power management system in which a power management server controls electric power consumed by an image processing apparatus.

2. Description of the Related Art

Wattmeters capable of measuring the electricity consumption in real time are spreading due to energy saving needs. For example, a wattmeter is incorporated into an image processing apparatus (for example, a printer) as office equipment, and makes it possible to manage the electricity consumption in real time. Also, the recent insufficient power supply from power companies demand enterprises to restrict the electricity consumption and level power peaks. Power management in an enterprise is performed by managing the power consumption not for each user but for each group, for example, each building, each area, or each organization, so the user consumes power within a range managed for each group.

Japanese Patent Laid-Open No. 2008-182840 has disclosed a method of determining, when a printer starts operating, whether to allow the operation based on the power limiting value and the present electricity consumption. It is possible to manage and control the electric power consumed by the printer by determining whether to allow the printer to consume power when it starts operating.

The electric power consumed by an image processing apparatus takes a long time to reach the peak of power consumption from the start of a function. Also, while a given image processing apparatus is performing processing, another image processing apparatus may increase the power consumption. The method disclosed in Japanese Patent Laid-Open No. 2008-182840 determines whether to use a function based on the electricity consumption from the start of the function. In a case as described above, therefore, the power limiting value may be exceeded at the peak of power consumption. If the power limiting value is exceeded, the function of the printer may be restricted. This spoils the convenience because the user has executed processing but an error occurs during the process.

### SUMMARY OF THE INVENTION

According to one aspect of the present invention, there is provided a power management server for managing electric power for each of groups to which a plurality of image processing apparatuses belong, comprising: a management unit configured to manage a present electricity consumption, a reservation power value, and an upper-limiting power value for each group; a determination unit configured to, when accepting, from an image processing apparatus, a power reservation request for reserving electric power to be used, determine whether to permit power reservation for the power reservation request, in a group to which the image processing apparatus belongs, in accordance with whether a total of a power value notified by the power reservation request, a reservation power value of the group, and a present electricity consumption of the group exceeds an upper-limiting power value of the group; and a notification unit configured to notify a power reservation determination result from the determination unit as a response to the power reservation request, wherein if the determination unit determines that power reservation for the power reservation request is possible, the management unit performs power reservation by adding the power value notified by the power reservation request to the reservation power value of the group.

According to another aspect of the present invention, there is provided an image processing apparatus connected to a power management server for managing electric power to be used, comprising: a request unit configured to, when accepting an instruction to execute a function of the image processing apparatus, transfer, to the power management server, a power reservation request for reserving electric power necessary to use the function; and a control unit configured to permit or restrict execution of the function in accordance with a power reservation determination result accepted as a response to the power reservation request.

According to another aspect of the present invention, there is provided a power management system including a plurality of image processing apparatuses, and a power management server for managing electric power for each of groups to which the plurality of image processing apparatuses belong, wherein the image processing apparatus comprises: an instruction unit configured to, when accepting an instruction to execute a function of the image processing apparatus, transfer, to the power management server, a power reservation request for reserving electric power necessary to use the function; and a control unit configured to permit or restrict execution of the function in accordance with a power reservation determination result accepted as a response to the power reservation request, the power management server comprises: a management unit configured to manage a present electricity consumption, a reservation power value, and an upper-limiting power value for each group; a determination unit configured to, when accepting, from the image processing apparatus, the power reservation request, determine whether to permit power reservation for the power reservation request, in a group to which the image processing apparatus belongs, in accordance with whether a total of a power value notified by the power reservation request, a reservation power value of the group, and a present electricity consumption of the group exceeds an upper-limiting power value of the group; and a notification unit configured to notify a power reservation determination result from the determination unit as a response to the power reservation request, and if the determination unit determines that power reservation is possible because the upper-limiting power value is not exceeded, the management unit performs power reservation by adding the power value notified by the power reservation request to the reservation power value of the group.

According to another aspect of the present invention, there is provided a power management method of managing electric power for each of groups to which a plurality of image processing apparatuses belong, comprising: managing a present electricity consumption, a reservation power value, and an upper-limiting power value for each group; determining, when accepting, from an image processing apparatus, a power reservation request for reserving electric power to be used, whether to permit power reservation for the power reservation request, in a group to which the image processing apparatus belongs, in accordance with whether a total of a power value notified by the power reservation request, a reservation power value of the group, and a present electricity consumption of the group exceeds an upper-limiting power value of the group; and notifying a power reservation determination result from the determining step as a response to the power reservation request, wherein if it is determined in the determining step that power reservation for the power reservation request is possible, power reservation is performed in the management step by adding the power value notified by the power reservation request to the reservation power value of the group.

According to another aspect of the present invention, there is provided a control method of an image processing apparatus connected to a power management server for managing electric power to be used, comprising: transferring, when accepting an instruction to execute a function of the image processing apparatus, to the power management server, a power reservation request for reserving electric power necessary to use the function; and permitting or restricting execution of the function in accordance with a power reservation determination result accepted as a response to the power reservation request.

According to another aspect of the present invention, there is provided a non-transitory computer-readable medium storing a program which causes a computer to function as: a management unit configured to manage a present electricity consumption, a reservation power value, and an upper-limiting power value for groups to which a plurality of image processing apparatuses belong, respectively; a determination unit configured to, when accepting, from an image processing apparatus, a power reservation request for reserving electric power to be used, determine whether to permit power reservation for the power reservation request, in a group to which the image processing apparatus belongs, in accordance with whether a total of a power value notified by the power reservation request, a reservation power value of the group, and a present electricity consumption of the group exceeds an upper-limiting power value of the group; and a notification unit configured to notify a power reservation determination result from the determination unit as a response to the power reservation request, wherein if the determination unit determines that power reservation for the power reservation request is possible, the management unit performs power reservation by adding the power value notified by the power reservation request to the reservation power value of the group.

According to another aspect of the present invention, there is provided a non-transitory computer-readable medium storing a program which causes a computer to function as: a request unit configured to, when accepting an instruction to execute a function of the computer, transfer, to a power management server, a power reservation request for reserving electric power necessary to use the function; and a control unit configured to permit or restrict execution of the function in accordance with a power reservation determination result accepted as a response to the power reservation request.

In the present invention, electric power to be used by an image processing apparatus is reserved in a power management server. This makes it possible to secure electric power while a function is used, and restrict electric power without spoiling the convenience for the user.

Further features of the present invention will become apparent from the following description of exemplary embodiments (with reference to the attached drawings).

### BRIEF DESCRIPTION OF THE DRAWINGS

FIG. 1 is a view showing the configuration of a power management system;

FIG. 2 is a view showing the hardware configurations of a power management server, client, and printer;

FIG. 3 is a view showing the software configuration of the power management server;

FIG. 4 is a view showing configuration examples of data managed by the power management server;

FIG. 5 is a view showing the software configuration of the printer;

FIGS. 6A, 6B, 6C, and 6D are views showing examples of a printer screen;

FIG. 7 is a view showing the software configuration of a power control unit;

FIG. 8 is a view showing configuration examples of data managed by the power control unit;

FIG. 9 is a flowchart of a power reservation requesting process in the power control unit;

FIG. 10 is a flowchart of a power reservation canceling process in the power control unit;

FIG. 11 is a flowchart of a start process in a copy application;

FIG. 12 is a flowchart of a power reservation waiting process in the copy application;

FIG. 13 is a flowchart of process execution in the copy application;

FIG. 14 is a flowchart of a terminating process in the copy application;

FIG. 15 is a flowchart of a power reservation request accepting process in the power management server; and

FIG. 16 is a flowchart of a power reservation cancellation request accepting process in the power management server.

### DESCRIPTION OF THE EMBODIMENTS

Embodiments for carrying out the present invention will be explained below with reference to the accompanying drawings.

### First Embodiment

### Overall System Configuration

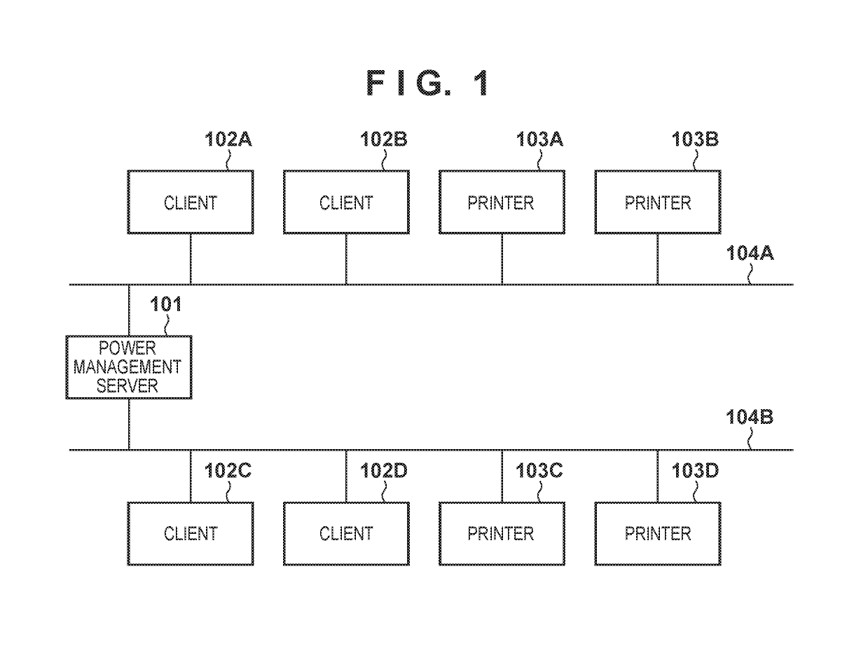

FIG. 1 is a view showing the overall configuration of a power management system according to an embodiment of the present invention.

Referring to FIG. 1, a power management server 101, clients 102A to 102D, and printers 103A to 103D are connected via networks 104A and 104B. In FIG. 1, it is assumed that a plurality of apparatuses are connected as the clients 102A to 102D and printers 103A to 103D. Each of the networks 104A and 104B can be any of a LAN and WAN of the Internet or the like, a telephone line, a dedicated digital line, an ATM or frame relay line, a cable television line, and a data broadcasting wireless channel. It is also possible to use a so-called communication network implemented by combining them. The networks 104A and 104B need only be capable of exchanging data. Communicating unit from the clients 102A to 102D to the power management server 101 and printers 103A to 103D and communicating unit from the printers 103A to 103D to the power management server 101 can be different.

In this specification, the clients 102A to 102D will be described as a client 102, the printers 103A to 103D will be described as a printer 103, and the networks 104A and 104B will be described as a network 104 hereinafter. Note that the printer 103 is described as an example in this specification, but the present invention is not limited to this. For example, it is also possible to use a multi-function peripheral (MFP) having a plurality of functions, or another image processing apparatus.

[Hardware Configuration]

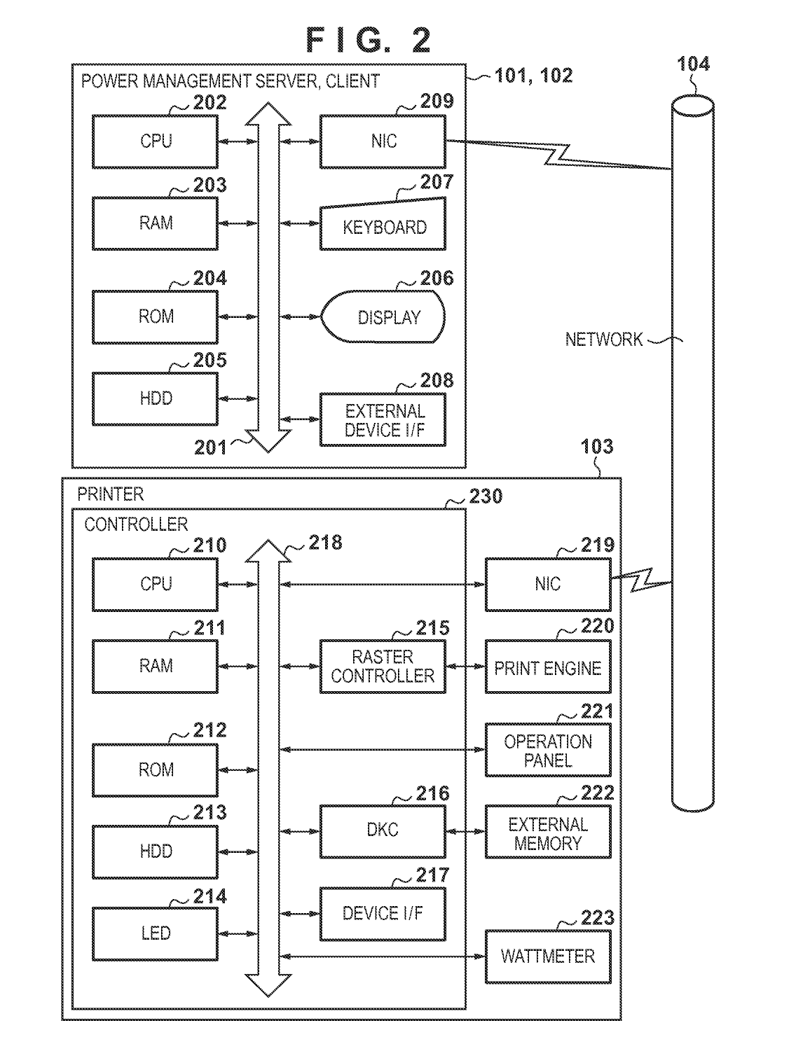

FIG. 2 is a view showing examples of the hardware configurations of the power management server 101, client 102, and printer 103 of the power management system according to the embodiment of the present invention. Note that the power management server 101 and client 102 have the same configuration in this embodiment, and an explanation will be made by taking the power management server 101 as an example.

Referring to FIG. 2, a CPU 202 controls the whole apparatus. That is, the CPU 202 executes application programs, an OS, and the like stored in a hard disk (HDD) 205, and performs control of temporarily storing, in a RAM 203, information, files, and the like necessary to execute the programs. A ROM 204 is a storage unit, and stores programs such as a basic I/O program, printing data to be used in a printing process, and various kinds of data such as printer information. The RAM 203 is a temporary storage unit, and functions as a main memory, work area, and the like of the CPU 202.

The HDD (hard disk) 205 is an external storage unit, and functions as a large-capacity memory. The HDD 205 stores, for example, application programs such as a Web browser, a print server program, the OS, and relevant programs. A display 206 is a display unit, and displays, for example, commands input from a keyboard 207, and a printer status. An external device I/F 208 is an interface (I/F) for connecting a printer, USB device, and peripheral device. The keyboard 207 is an instruction input unit.

A system bus 201 controls flows of data inside the power management server 101 and client 102. A network interface card (NIC) 209 exchanges data with an external apparatus connected via the network 104. Note that the above-described computer arrangement is an example, so the arrangement is not limited to the configuration example shown in FIG. 2. For example, the storage destination of data or a program can be changed to a ROM, RAM, HDD, or the like in accordance with the feature of the data or program.

Next, the hardware configuration of the printer 103 will be explained. A controller 230 is a controller of the printer 103, and functions as a printer control system. A CPU 210 controls the whole apparatus, and comprehensively controls accesses to various devices connected to a system bus 218. This control is based on, for example, a control program stored in a ROM 212, or a control program and resource data (resource information) stored in an external memory 222 connected via a disk controller (DKC 216).

A RAM 211 functions as a main memory, work memory, and the like of the CPU 210, and is configured to be able to increase the memory capacity by an optional RAM connected to an expansion port. An HDD 213 functions as a large-capacity memory, and stores, for example, programs running on the printer 103. An operation panel (operation unit) 221 includes a user interface for performing printing operations. The operation panel 221 also includes buttons and a display unit such as a liquid crystal panel or LED 214 for setting, e.g., the operation mode of the printer 103, displaying the operation status of the printer 103, and performing operations such as copy designation. A network interface card (NIC) 219 exchanges data with an external apparatus via the network 104.

A raster controller 215 is a controller for converting printing data such as PDL (Page Description Language) data or PDF (Portable Document Format) data into image data. A device I/F 217 is a connection I/F for connecting to an external device connectable by a USB or the like. A wattmeter 223 is an electrical device for measuring the electric power used by the printer 103. The wattmeter 223 always monitors the present electricity consumption (watt) of the printer 103. Note that the wattmeter 223 can also monitor the electric power used by each function of the printer 103, in addition to the overall electricity consumption of the printer 103.

Note that a print engine 220 shown in FIG. 2 uses the existing printing technique, for example, the electrophotographic method (laser beam method), inkjet method, or sublimation (thermal transfer) method.

[Power Management Server]

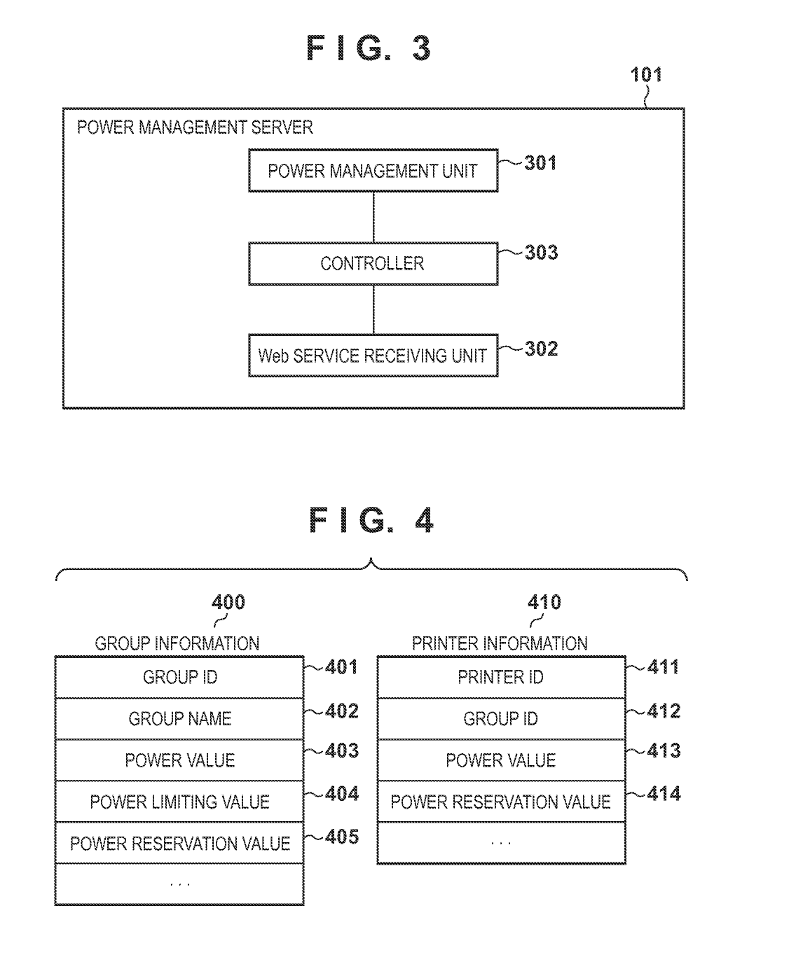

FIG. 3 is a view showing an example of the software configuration of the power management server 101 according to this embodiment. Note that each software module of the power management server 101 is stored in the HDD 205 shown in FIG. 2, and loaded into the RAM 203 and executed by the CPU 202 as described previously. Note also that group information 400 and printer information 410 held by the power management server 101 are saved in the HDD 205, loaded into the RAM 203, and used by programs of the power management server 101.

The power management server 101 includes a power management unit 301, Web service receiving unit 302, and controller 303. The power management unit 301 holds the group information 400 and printer information 410, and updates the values of the group information 400 and printer information 410 based on a request accepted by the Web service receiving unit 302, thereby performing power reservation and cancellation. Note that in this specification, a process of reserving, in the power management server 101, electric power required for the printer 103 to execute each function so that the electric power is usable will be described as “power reservation”. Note also that a process of canceling reserved electric power will be described as “power reservation cancellation”. The Web service receiving unit 302 receives a power reservation request (power reservation demand), power reservation cancellation request (power reservation cancellation demand), and power notification (reservation result notification) from the printer 103, and returns responses. The controller 303 manages the operation of the overall power management, and issues operation instructions to the power management unit 301 and Web service receiving unit 302.

Note that the power management server 101 may also be implemented by physically separated devices. Note also that the services provided by the power management server 101 may also be implemented by, for example, applying the services to the cloud service.

The group information 400 and printer information 410 shown in FIG. 4 are configuration examples of data held by the power management unit 301 of the power management server 101.

The group information 400 contains a group ID 401, group name 402, power value 403, power limiting value 404, and power reservation value 405. The group ID 401 is an identifier by which the group is uniquely identifiable, and is a UUID (Universal Unique Identifier). The group name 402 is a name given to the group. The power value 403 is the total of the present power values consumed in the printers 103 belonging to the group. The power limiting value 404 is the upper limit (upper-limiting power value) of a usable power value set for the group. The power limiting value 404 is normally freely set by the group administrator. The power reservation value 405 is the total of the power values reserved by the printers 103 belonging to the group.

The printer information 410 contains a printer ID 411, group ID 412, power value 413, and power reservation value 414. The printer ID 411 is an identifier by which the printer 103 is uniquely identifiable, and a UUID added to various requests from the printer 103 is held as the identifier. The group ID 412 is an identifier by which a group to which the printer belongs is uniquely identifiable, and corresponds to the group ID 401 held in the group information 400. The printer 103 is normally grouped in a given group, and the printers 103 having the same group ID 412 are managed as the same group. The power value 413 is the present power value consumed by the printer 103, and a power value notified by a power notification from the printer 103 is stored. The power reservation value 414 is the total power value reserved by the printer 103. When power reservation is permitted for a power reservation request from the printer 103, the requested power value is added to the power reservation value 414. Also, when a power reservation cancellation request is accepted, the requested power value is subtracted from the power reservation value 414.

Note that the above-mentioned data structures are examples and may also contain other items and information.

[Client 102]

The client 102 is, for example, a desktop personal computer, laptop personal computer, mobile personal computer, or PDA (Personal Data Assistant). However, the client 102 may also be a cell phone incorporating a program execution environment, or another device.

Note that programs running on the client 102 are stored in the HDD 205 shown in FIG. 2, and loaded into the RAM 203 and executed by the CPU 202 as described earlier. Note also that data held in the client 102 is saved in the HDD 205, loaded into the RAM 203, and used by programs.

[Printer 103]

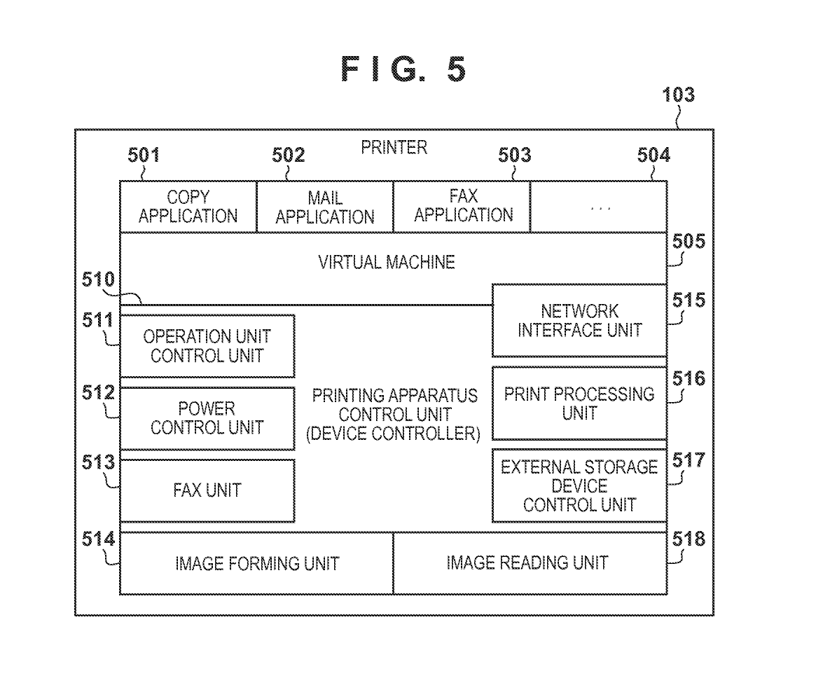

FIG. 5 is a view showing the software configuration of the printer 103 as a hierarchical structure. Each software module of the printer 103 is stored in the HDD 213 shown in FIG. 2, and loaded into the RAM 211 and executed by the CPU 210 as described previously. Also, data held in the printer 103 is saved in the HDD 213, loaded into the RAM 211, and used by programs of the printer 103.

Referring to FIG. 5, an image forming unit 514 forms an image on a printing medium such as printing paper by executing a series of image formation processes such as paper handling, image transfer, and fixation. The image forming unit 514 includes an inkjet printer or electrophotographic image forming unit (not shown).

An image reading unit 518 includes a scanner or the like. The image reading unit 518 optically reads an original image, and converts the read image into digital image information. Also, the image reading unit 518 forms an image by outputting digital image information to the image forming unit 514, or transfers the digital image information to a FAX unit 513 or network interface unit 515 and transmits the information through a line.

A device controller 510 controls the operations of the image forming unit 514 and image reading unit 518. For example, the device controller 510 performs control such that the image forming unit 514 copies original information read by the image reading unit 518. Also, the device controller 510 includes an operation unit control unit 511, a power control unit 512, the FAX unit 513, the network interface unit 515, a print processing unit 516, and an external storage device control unit 517, and controls information exchange between these units. Note that the device controller 510 may also include other control units.

The operation unit control unit 511 performs control so as to generate a signal corresponding to a user's operation using the operation panel 221 of the operation unit, or display various data, messages, and the like on the operation unit (or display unit). The FAX unit 513 exchanges facsimile images, that is, executes a process of transferring digital image information read by the image reading unit 518, and a process of decoding a received facsimile image and printing the decoded image by the image forming unit 514. The network interface 515 controls data exchange with other communication terminals through a communication line.

The print processing unit 516 performs control to, for example, process printing data input via the network interface unit 515, output the processed data to the image forming unit 514, and print the data. The external storage device control unit 517 converts an image read by the image reading unit 518 into a data format savable in an external storage device by the image forming unit 514, and saves the data in the external storage device. Also, the external storage device control unit 517 reads out data saved in the external storage device, and prints the readout data via the image forming unit 514, or transfers the data outside via the network interface unit 515.

A virtual machine 505 is a host device of the device controller 510, and configured to be able to control the device controller 510. Also, the device controller 510 and virtual machine 505 can directly use the network interface unit 515, and can access the external network independently of each other. Furthermore, applications described by a programming language corresponding to the API (Application Programming Interface) provided by the virtual machine 505 exist in the upper layer of the virtual machine 505.

These applications can indirectly act on the device controller 510 via the virtual machine 505, and can also operate the image forming unit 514 and image reading unit 518. As these applications, this embodiment includes a copy application 501, mail application 502, and FAX application 503. Details of these applications will be described later. Also, these applications are configured so that they can be uninstalled from the virtual machine 505 or can be installed as a new application 504. In this embodiment, the above-described applications have been explained as applications installed in the printer 103. However, these applications may also be installed as hardware, or exist as applications on a computer communicably connected as an external apparatus to the printer 103.

[Printer Screen]

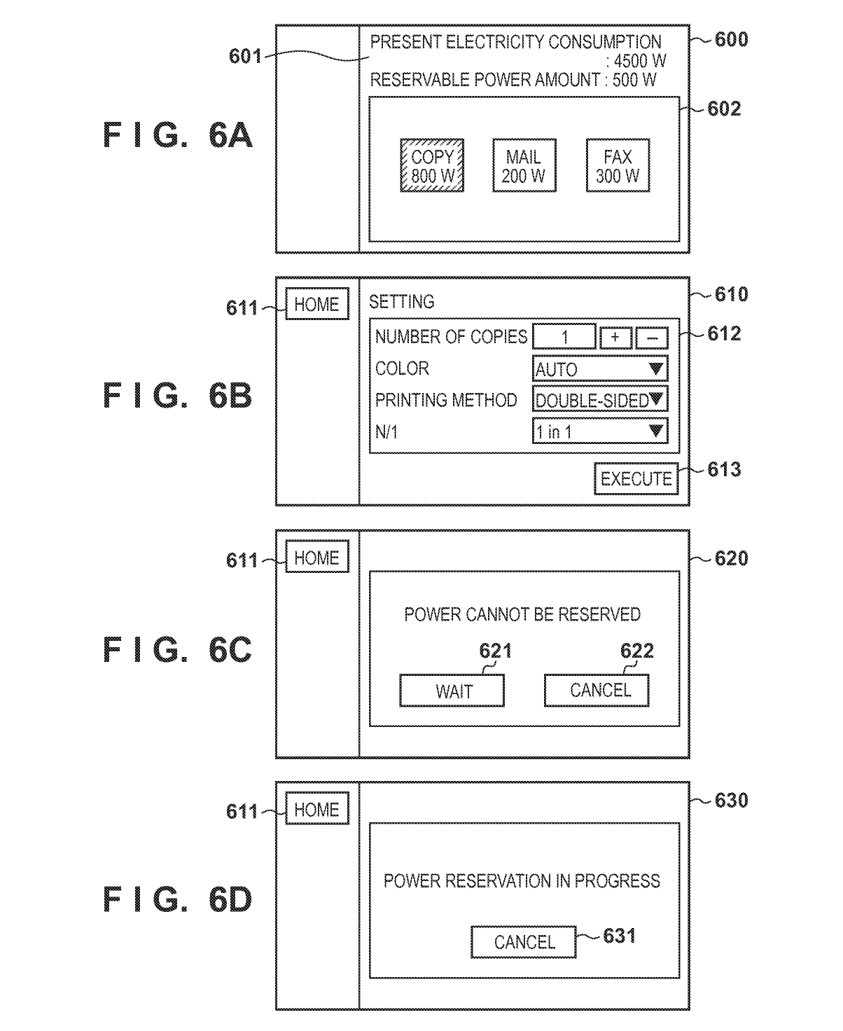

FIGS. 6A to 6D are views showing examples of a screen generated by the operation unit control unit 511 or copy application 501 of the printer according to this embodiment, and displayed on the operation panel 221 by the operation unit control unit 511.

A home screen 600 shown in FIG. 6A is a screen generated by the operation unit control unit 511, and includes a power display area 601 and application selection area 602. The power display area 601 displays the present power value in a location to which the printer 103 belongs, and a reservable power value in the location to which the printer 103 belongs. The power control unit 512 of the printer 103 periodically notifies the power management server 101 of the power value consumed by the printer 103. Also, the power control unit 512 receives, as a response to the power value notification, power value information to be displayed in the power display area 601 from the power management server 101, and displays the received information.

Application buttons for activating the various applications installed in the printer 103 are arranged in the application selection area 602. FIG. 6A shows an example in which buttons for activating the copy application 501, mail application 502, and FAX application 503 are arranged. When any of these buttons is pressed, a corresponding application is called, and a screen generated by the application is displayed on the operation panel 221. In addition, each application button displays a maximum power value necessary for the application. If the power value usable in the location does not reach the maximum power value necessary for an application, an application button corresponding to the application is grayed out. For example, the usable value of the location is 500 W, that is, does not reach a maximum power value of 800 W necessary for the copy application 501, so the application button of the copy application is grayed out.

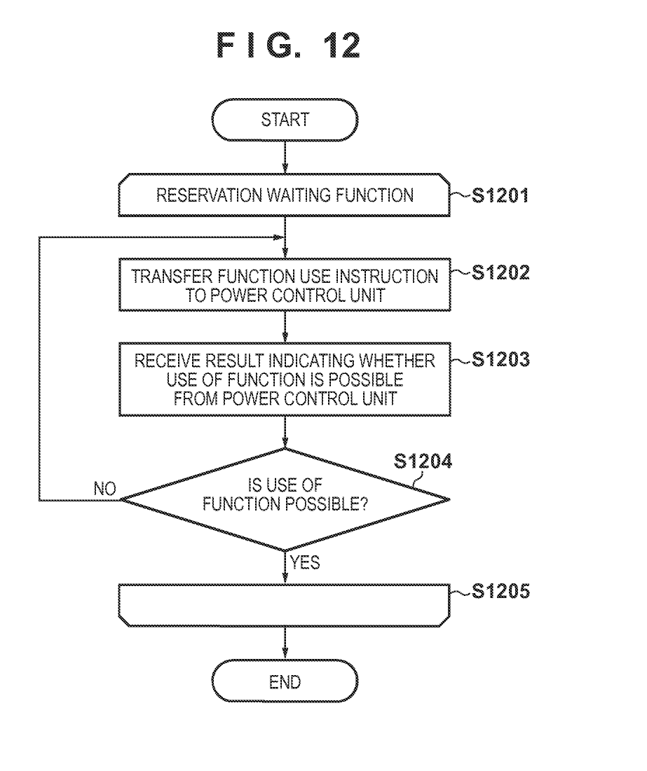

Note that in this embodiment, power reservation waiting can be performed even when the usable power is lower than the necessary power and an application button is grayed out. Therefore, the user can press even a grayed-out application button. This processing will be described later with reference to FIG. 12 and the like.

A copy main screen 610 shown in FIG. 6B is a copy setting screen generated by the copy application 501, and includes a home button 611, copy setting area 612, and execute button 613. The copy main screen 610 is displayed when the copy application button displayed in the application selection area 602 of the home screen 600 is pressed. When the home button 611 on the copy main screen 610 is pressed, the copy application 501 is terminated, and the home screen 600 returns. The copy setting area 612 is an area for designating options of copy execution, and it is possible to designate, for example, the number of copies, a color printing method, and N/1 printing. The execute button 613 is a button for instructing the start of copying.

A copy power reservation failure screen 620 shown in FIG. 6C is displayed if scanning power reservation or printing power reservation fails during power reservation when the copy application 501 is activated. That is, a copying process includes a scanning process and printing process, and the copy power reservation failure screen 620 is displayed if power reservation for either function fails. The copy power reservation failure screen 620 is generated by the copy application 501, and includes a message, reservation wait button 621, and cancel button 622. When the reservation wait button 621 is pressed, power reservation waiting is executed, and the copy main screen 610 is displayed, thereby implementing a reservation waiting accepting unit. Details of the power reservation waiting process will be described later with reference to FIG. 12 and the like. When the cancel button 622 is pressed, the copy application 501 is terminated, and the home screen 600 is displayed.

A copy power reservation waiting screen 630 shown in FIG. 6D is a screen generated by the copy application 501 and indicating that power reservation is in progress, and includes a message and cancel button 631. When the cancel button 631 is pressed, the copy application 501 is terminated, and the home screen 600 is displayed.

[Power Control Unit 512]

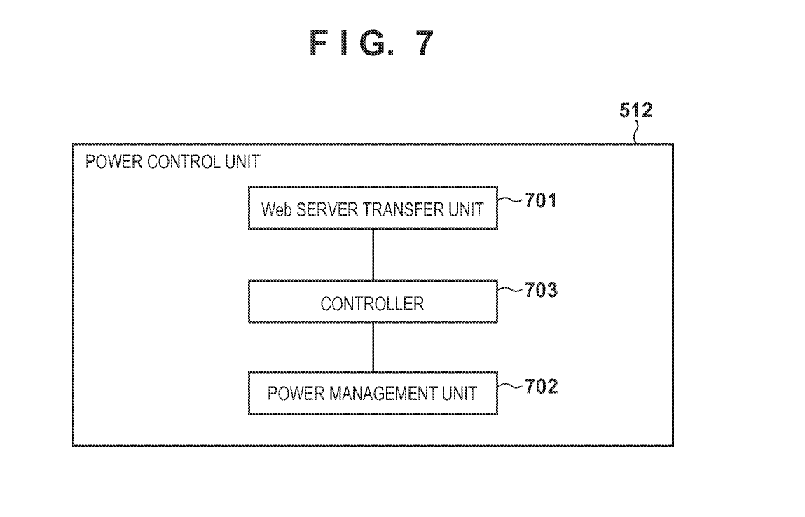

FIG. 7 is a view showing the software configuration of the power control unit 512 according to this embodiment. Note that each software module of the power control unit 512 is stored in the HDD 213, and loaded into the RAM 211 and executed by the CPU 210 as described earlier. Note also that printer information 800 and power information 810 held in the power control unit 512 are held on the RAM 211 and used by programs of the power control unit 512.

The power control unit 512 includes a Web service transfer unit 701, power management unit 702, and controller 703. The Web service transfer unit 701 transfers a power reservation request, power reservation cancellation request, and power notification to the power management server 101, and receives responses to these requests and notification. The power management unit 702 holds the printer information 800 and power information 810, and acquires power information of the printer 103 from the wattmeter 223. Also, the power management unit 702 accepts, from various applications running on the printer 103, an instruction (function use instruction) when using a function, and a notification (function use termination notification) indicating that the use of the function is terminated. The controller 703 manages the operation of the whole power control, and issues operation instructions to the Web service transfer unit 701 and power management unit 702.

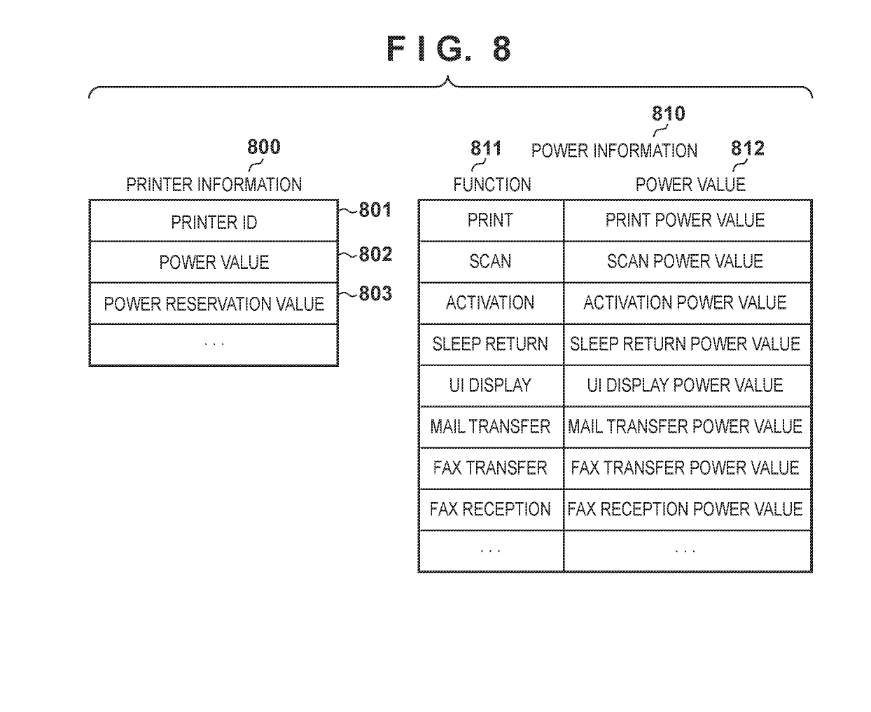

The printer information 800 and power information 810 shown in FIG. 8 indicate configuration examples of data held by the power management unit 702 of the power control unit 512.

The printer information 800 contains a printer ID 801, power value 802, and power reservation value 803. As the printer ID 801, a UUID is held as an identifier by which the printer 103 is uniquely identifiable. Note that the printer ID 801 has a value unique to each printer 103, and the value issued when the printer 103 is initially activated is kept held and unchanged. The printer ID 801 corresponds to the printer information 410 managed by the power management server 101. The power value 802 is the present power value consumed by the printer 103 and periodically acquired by the wattmeter 223. The power reservation value 803 is the total power value successfully reserved in the power management server 101 from the printer. The power value reserved when the power reservation request has succeeded is added to this total value. Also, the reserved power value is subtracted after the power reservation cancellation request.

The power information 810 is a list managed by a pair of a function 811 and power value 812. The power value 812 required when the printer 103 executes the function 811 is defined beforehand. The power information 810 changes in accordance with the performance of the printer 103. In the power reservation request, reservation is performed using the power value defined in the power information 810.

Note that the above-mentioned data structures are examples, and may also include other items and information.

[Printer Power Reservation Process Sequence]

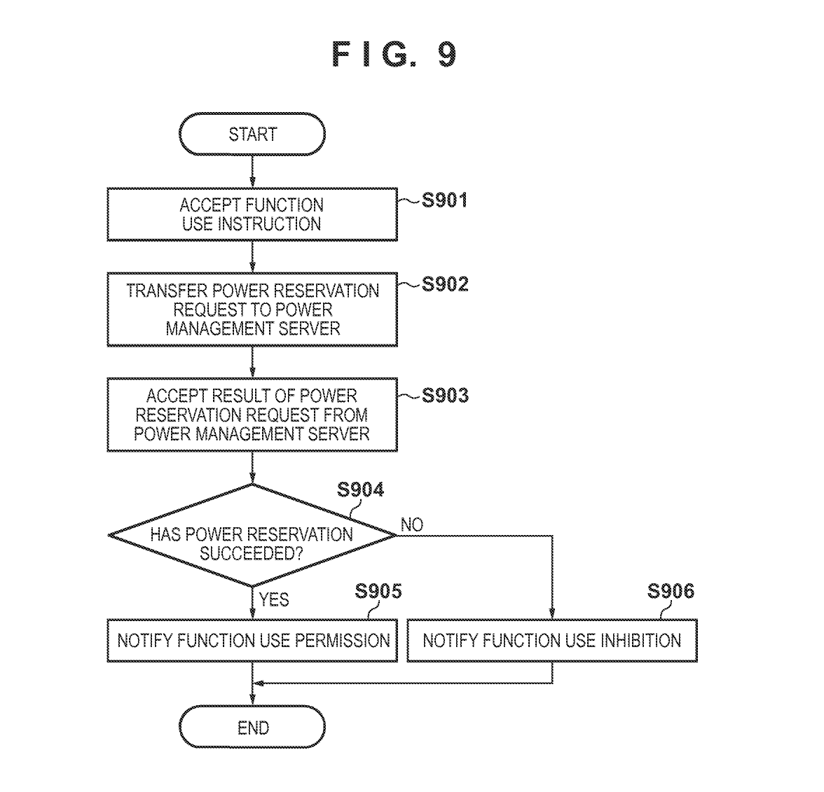

FIG. 9 shows a process sequence started when the power control unit 512 of the printer 103 accepts a function use instruction from an application on the printer 103, and ended when the power control unit 512 returns a response indicating the permission or restriction of the use of the function. Note that in this embodiment, the CPU 210 implements this process sequence by reading out a program held in the ROM 212 or HDD 213 as a storage unit to the RAM 211, and executing the readout program.

In step S901, the power control unit 512 accepts a function use instruction from an application on the printer 103. This function use instruction contains information of a function to be used, and the power control unit 512 specifies, from the power information 810, the power value 812 corresponding to the function 811 designated by the function use instruction. In step S902, the power control unit 512 transfers a power reservation request to the power management server 101. This power reservation request contains, as a reservation power value, the power value 812 corresponding to the function 811 designated by the function use instruction, and also contains the printer ID 801 for specifying the printer 103.

In step S903, the power control unit 512 receives the result of the power reservation request from the power management server 101. This result of the power reservation request contains information indicating whether the reservation power value for the designated function is reserved. In step S904, the power control unit 512 determines the success/failure of the power reservation based on the result of the power reservation request. If the power reservation has succeeded (YES in step S904), the process advances to step S905, and the power control unit 512 notifies the application having issued the function use instruction of the permission of the use of the function. If the power reservation has failed (NO in step S904), the process advances to step S906, and the power control unit 512 notifies the application having issued the function use instruction of the inhibition of the use of the function (that is, the restriction of the use of the function).

[Printer Power Reservation Cancellation Process Sequence]

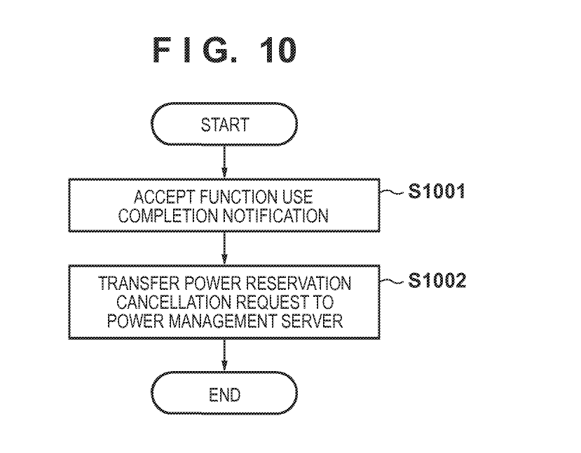

FIG. 10 shows a process sequence started when the power control unit 512 of the printer 103 accepts a function use completion notification from an application on the printer 103, and ended when the power control unit 512 performs a power reservation cancellation request. Note that in this embodiment, the CPU 210 implements this process sequence by reading out a program held in the ROM 212 or HDD 213 as a storage unit to the RAM 211, and executing the readout program.

In step S1001, the power control unit 512 accepts a function use completion notification from an application on the printer 103. This function use completion notification contains function information, and the power control unit 512 specifies, from the power information 810, the power value 812 corresponding to the function 811 designated by the function use completion notification.

In step S1002, the power control unit 512 transfers a power reservation cancellation request to the power management server 101. The power reservation cancellation request contains, as a reservation cancellation power value, the power value 812 corresponding to the function 811 designated by the function use completion notification, and also contains the printer ID 801 for specifying the printer 103. Then, this process sequence is terminated.

[Copy Application Start Process Sequence]

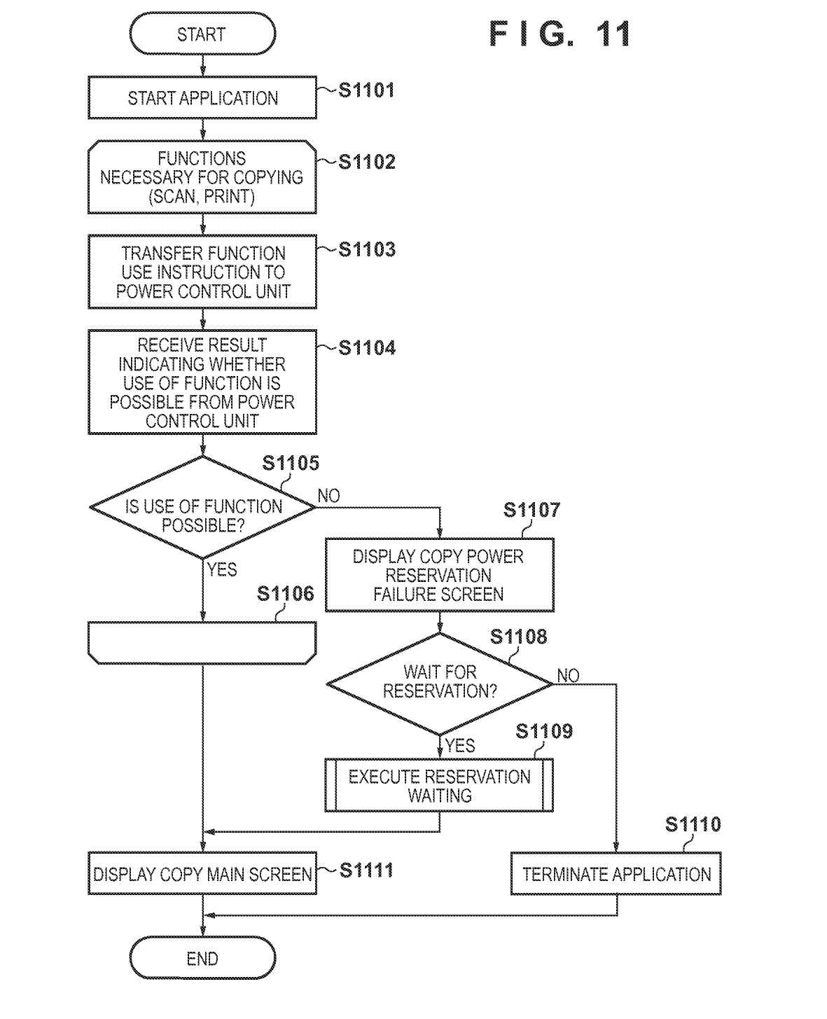

FIG. 11 shows a process sequence started when the copy application 501 is started, and ended when the copy main screen 610 is displayed. Note that in this embodiment, the CPU 210 implements this process sequence by reading out a program held in the ROM 212 or HDD 213 as a storage unit to the RAM 211, and executing the readout program.

In step S1101, the copy application program 501 detects application start. More specifically, when the copy application button is pressed in the application selection area 602 of the home screen 600, the copy application 501 is notified of application start. Also, when copy execution is completed or canceled and the copy main screen 610 is displayed again, the copy application 501 is notified of application start.

In steps S1102 to S1106, the copy application 501 sequentially designates functions necessary for copying with respect to the power control unit 512. As the functions necessary for copying, a scan function and print function are used. In step S1103, the copy application 501 designates a function to be used for the power control unit 512. In step S1104, the copy application 501 receives, from the power control unit 512, a result indicating whether the designated function is usable. If a result indicating the permission of the use of the function is received from the power control unit 512 (YES in step S1105), the copy application 501 continues the processing in steps S1102 to S1106 in order to perform confirmation on the next necessary function. If it is confirmed that all the necessary functions are usable, the process advances to step S1111.

If a result indicating the inhibition of the use of the function is received from the power control unit 512 (NO in step S1105), the process advances to step S1107, and the copy application 501 displays the copy power reservation failure screen 620 by regarding that no power reservation can be made for the function. If in step S1108 the copy application 501 detects the pressing of the reservation wait button 621 on the displayed copy power reservation failure screen 620 (YES in step S1108), the copy application 501 executes the reservation waiting process in step S1109, and the process advances to step S1111. The reservation waiting process in step S1109 will be described later with reference to FIG. 12.

If in step S1108 the copy application 501 detects the pressing of the cancel button 622 on the displayed copy power reservation failure screen 620 (NO in step S1108), the copy application 501 is terminated in step S1110. After that, the operation unit control unit 511 detects the termination of the application, and displays the home screen 600. If power reservation can be made by the reservation waiting process in step S1109, the copy application 501 displays the copy main screen 610 in step S1111. Then, this process sequence is terminated.

[Application Reservation Waiting Process Sequence]

As shown in FIG. 11, even when power reservation has failed and no power can be secured, it is possible to perform the reservation waiting process (step S1109) in the background and advance the operation on the displayed printer screen. Therefore, the user can continue the process setting until power reservation succeeds.

FIG. 12 is a reservation waiting process sequence started when the copy application 501 executes reservation waiting (step S1109) in FIG. 11. Note that in this embodiment, the CPU 210 implements this process sequence by reading out a program held in the ROM 212 or HDD 213 as a storage unit to the RAM 211, and executing the readout program.

In steps S1201 to S1205, the copy application 501 sequentially repeats function use instructions for functions inhibited from being used. The processing in steps S1202 to S1204 is the same as that in steps S1103 to S1105 described above, so a repetitive explanation will be omitted. Note that the interval of the repetition of the function use instruction is not particularly limited. Note also that the administrator of the printer 103 can freely set this instruction transfer interval, or a fixed value can be defined as the interval.

The copy application 501 repeats the function use instruction until the use of a function waiting for reservation is permitted (YES in step S1204). Note that although not shown in FIG. 12, if the function use instruction is repeated a predetermined number of times or more or if a predetermined time has elapsed since the reservation waiting instruction is accepted, this process sequence can also be terminated.

[Copy Application Execution Process Sequence]

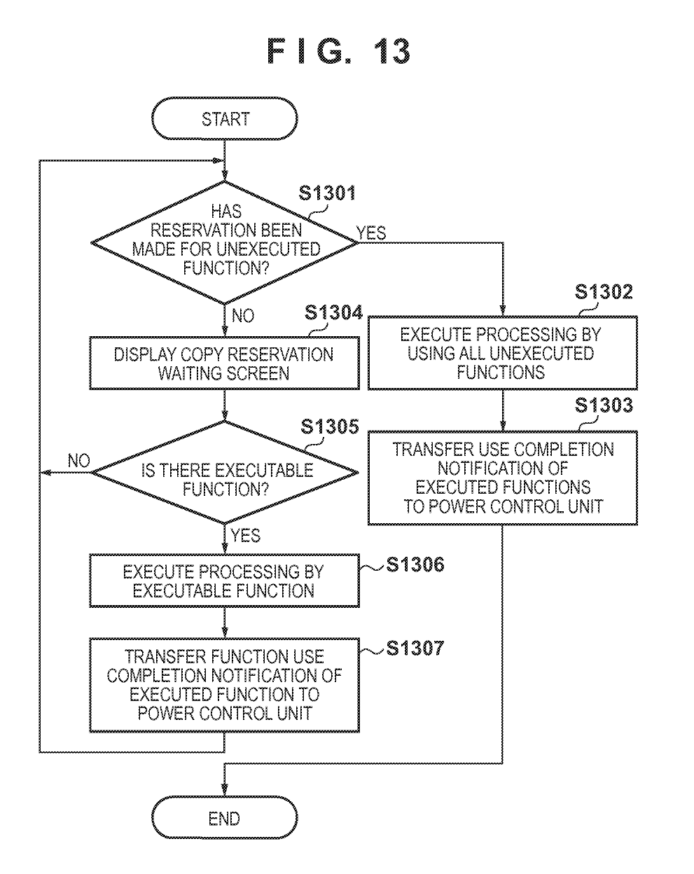

FIG. 13 shows a process sequence started when the copy application 501 detects the pressing of the execute button 613 on the copy main screen 610, and ended when the copy application 501 executes copying. Note that in this embodiment, the CPU 210 implements this process sequence by reading out a program held in the ROM 212 or HDD 213 as a storage unit to the RAM 211, and executing the readout program.

In step S1301, the copy application 501 checks the presence/absence of a function inhibited from being used. That is, the copy application 501 checks whether power reservation has been made for all unexecuted functions required to be used. If power reservation has been made for all the unexecuted functions (YES in step S1301), the copy application 501 starts executing the unexecuted functions in step S1302. After the execution of the processing is completed, the process advances to step S1303, and the copy application 501 notifies the power control unit 512 of the executed functions (function use completion notification).

If there is an unexecuted function for which no power reservation has been made (NO in step S1301), the copy application 501 displays the copy power reservation waiting screen 630 in step S1304. In step S1305, the copy application 501 determines the presence/absence of a function executable at present, among the functions for which power reservation has been made. That is, the copy application 501 determines whether there is a function for which power reservation has been made and which is independently executable, even when no power reservation has been made for other functions. If there is an executable function (YES in step S1305), the copy application 501 executes the processing of the executable function in step S1306. After the execution of the processing is completed, the process advances to step S1307, and the copy application 501 notifies the power control unit 512 of the executed function (function use completion notification). Then, the copy application 501 returns to step S1301 and continues the process. That is, the copy application 501 waits until power reservation is performed for the function required to be used.

If there is no executable function (step S1305), the copy application 501 returns to step S1301 and continues the process. That is, the copy application 501 waits until power reservation is performed for the function required to be used.

By using the process sequence explained with reference to FIG. 13, even when power reservation for some functions has failed in processing requiring the use of a plurality of functions, the processing can be executed in some cases. For example, copying is a composite function of scanning and printing. Even when power reservation has succeeded for the scan function but has failed for the print function, the scan function can be executed independently of the print function. Therefore, the scan function for which power reservation has been made is executed. If power reservation for the print function has succeeded in the background while scanning is executed, the printing process can also be executed following the scanning process. This improves the convenience.

Note that this process sequence is applicable not only to the copy function, but also when there is processing to be executed by using a plurality of functions.

[Copy Application Termination Process Sequence]

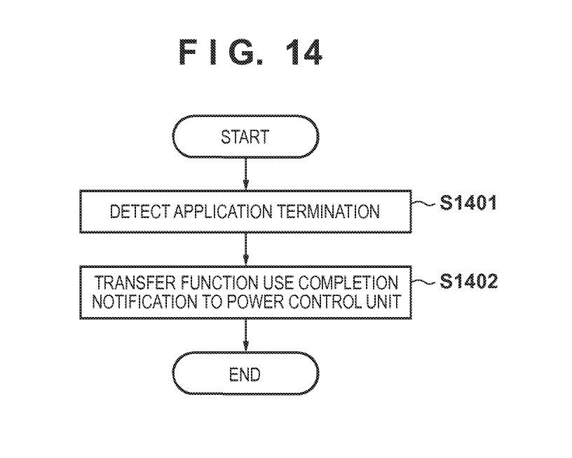

FIG. 14 shows a process sequence started when the copy application 501 detects the termination of an application, and ended when an application terminating process is completed. Note that in this embodiment, the CPU 210 implements this process sequence by reading out a program held in the ROM 212 or HDD 213 as a storage unit to the RAM 211, and executing the readout program.

In step S1401, the copy application 501 detects application termination. More specifically, when the pressing of the home button 611 is detected while the screen of the copy application 501 is displayed, the operation unit control unit 511 notifies the copy application 501 of application termination. Also, if no operation is performed on the screen of the copy application 501 for a predetermined time while the screen is displayed, the operation unit control unit 511 notifies the copy application 501 of application termination.

In step S1402, the copy application 501 transfers a function use completion notification to the power control unit 512 for a function permitted to be used. When the application terminating process of the copy application 501 shown in FIG. 14 is completed, the operation unit control unit 511 displays the home screen 600.

[Process Sequence in which Power Management Server Accepts Power Reservation Request]

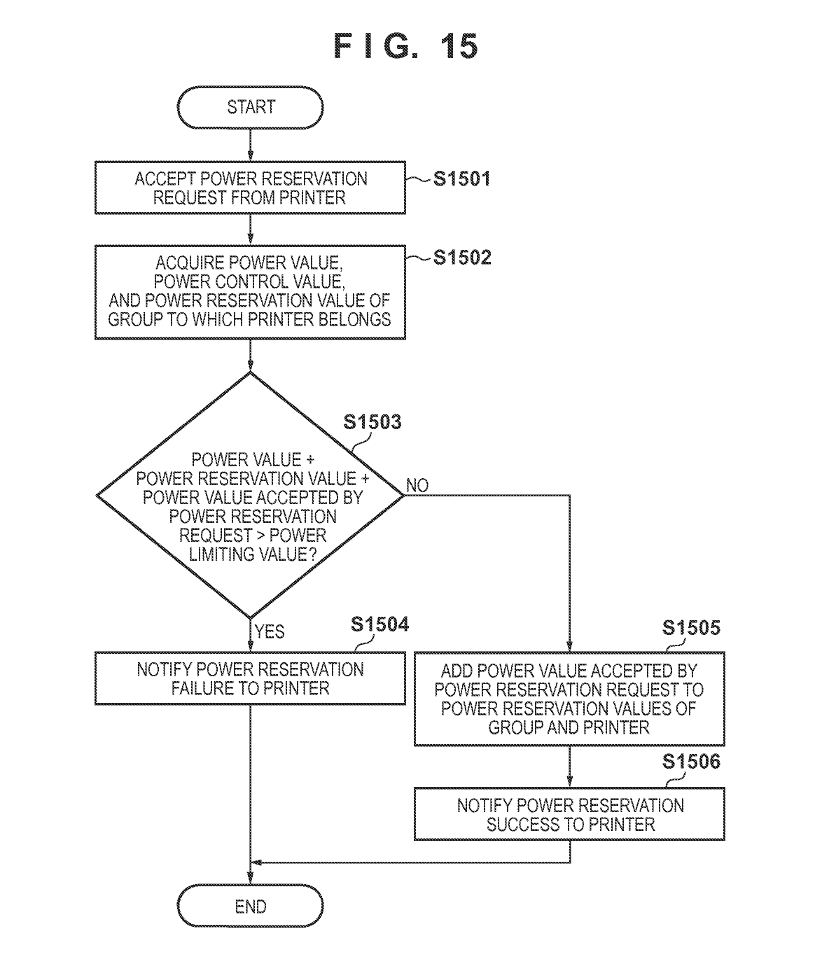

FIG. 15 shows a process sequence started when the power management server 101 accepts a power reservation request from the printer 103, and ended when the power management server 101 returns a power reservation result (success/failure) to the printer 103. Note that in this embodiment, the CPU 202 implements this process sequence by reading out a program held in the ROM 204 or HDD 205 as a storage unit to the RAM 203, and executing the readout program.

In step S1501, the power management server 101 accepts a power reservation request from the printer 103. The power reservation request contains the reservation power value and printer ID. In addition, the power management server 101 specifies the printer information 410 from the printer ID 411 notified by the power reservation request. Furthermore, the power management server 101 specifies the group information 400 from the group ID 412 of the specified printer information 410. In step S1502, the power management server 101 acquires the power value 403, power limiting value 404, and power reservation value 405 from the specified group information 400.

In step S1503, the power management server 101 determines whether the total of the power value 403, the power reservation value 405, and the reservation power value notified by the power reservation request has exceeded the power limiting value 404. If the total value has exceeded the power limiting value 404 (YES in step S1503), the process advances to step S1504, and the power management server 101 notifies the printer 103 having issued the power reservation request of a power reservation failure. If the total value has not exceeded the power limiting value 404 (NO in step S1503), the process advances to step S1505, and the power management server 101 adds the reservation power value accepted by the power reservation request to the power reservation values 405 and 414 of the specified group and printer. In step S1506, the power management server 101 notifies the printer 103 having issued the power reservation request of a power reservation success. Then, this process sequence is terminated.

[Process Sequence in which Power Management Server Accepts Power Reservation Cancellation Request]

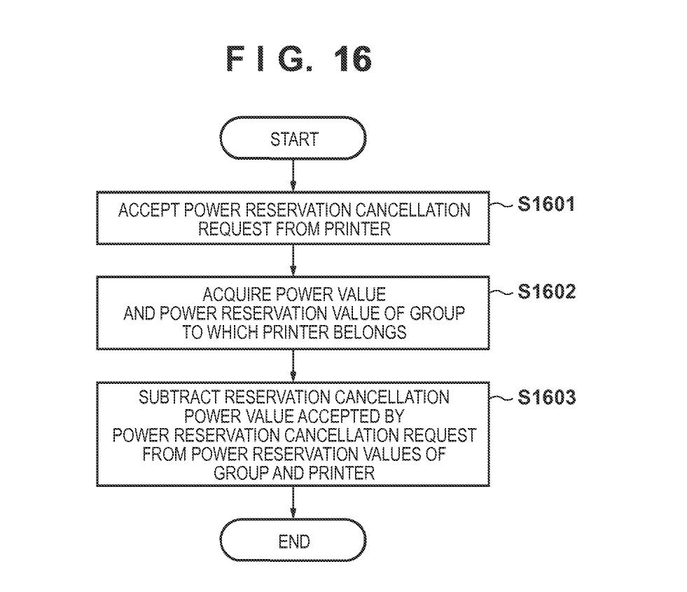

FIG. 16 shows a process sequence in which the power management server 101 accepts a power reservation cancellation request from the printer 103 and cancels power reservation. Note that in this embodiment, the CPU 202 implements this process sequence by reading out a program held in the ROM 204 or HDD 205 as a storage unit to the RAM 203, and executing the readout program.

In step S1601, the power management server 101 accepts a power reservation cancellation request from the printer 103. The power reservation cancellation request contains the reservation cancellation power value and printer ID. In addition, the power management server 101 specifies the printer information 410 from the printer ID 411 notified by the power reservation cancellation request. Furthermore, the power management server 101 specifies the group information 400 from the group ID 412 of the specified printer information 410. In step S1602, the power management server 101 acquires the power value 403 and power reservation value 405 from the specified group information 400.

In step S1603, the power management server 101 subtracts the reservation cancellation power value accepted by the power reservation cancellation request from the power reservation values 405 and 414 of the specified group and printer. Then, this process sequence is terminated.

Note that the printer information 800 and power information 810 used in the process sequences shown in FIGS. 9 to 14 are saved in the HDD 213, loaded into the RAM 211, and used by programs on the printer 103.

Note also that the group information 400 and printer information 410 used in the process sequences shown in FIGS. 15 and 16 are saved in the HDD 205, loaded into the RAM 203, and used by programs in the power management server 101.

In the present invention as described above, when using various functions of an image processing apparatus, power values are reserved in the power management server, and only functions for which the reservation is made are executed. Since the power reservation is performed at the start of the use of a function, it is possible to secure electric power necessary to use the function, so the power limiting value is not exceeded while the process is executed.

Also, the process is always executed after the reservation is made, so the power limiting value is not exceeded even when using a plurality of image processing apparatuses. When an image processing apparatus performs power reservation in the power management server, therefore, it is possible to secure electric power while the function is used, and limit electric power without spoiling the convenience for the user.

### Other Embodiment

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-031044, filed Feb. 15, 2012, which is hereby incorporated by reference herein in its entirety.

What is claimed is:

1. A power management server for managing electric power for each of groups to which a plurality of image processing apparatuses belong, comprising:
a management unit configured to manage a present electricity consumption, a reservation power value, and an upper-limiting power value for each group;
a determination unit configured to, when accepting, from an image processing apparatus, a power reservation request for reserving electric power to be used, determine whether to permit power reservation for the power reservation request, in a group to which the image processing apparatus belongs, in accordance with whether a total of a power value notified by the power reservation request, a reservation power value of the group, and a present electricity consumption of the group exceeds an upper-limiting power value of the group; and
a notification unit configured to notify a power reservation determination result from said determination unit as a response to the power reservation request,
wherein if said determination unit determines that power reservation for the power reservation request is possible, said management unit performs power reservation by adding the power value notified by the power reservation request to the reservation power value of the group.

2. The server according to claim 1, wherein when accepting a power reservation cancellation request for canceling power reservation from an image processing apparatus, said management unit cancels the power reservation, in a group to which the image processing apparatus belongs, by subtracting a power value notified by the power reservation cancellation request from a reservation power value of the group.

3. An image processing apparatus connected to a power management server for managing electric power to be used, comprising:
a request unit configured to, when accepting an instruction to execute a function of the image processing apparatus, transfer, to said power management server, a power reservation request for reserving electric power necessary to use the function; and
a control unit configured to permit or restrict execution of the function in accordance with a power reservation determination result accepted as a response to the power reservation request.

4. The apparatus according to claim 3, further comprising a cancellation request unit configured to, when execution of a function is completed, transfer a power reservation cancellation request for canceling power reservation to said power management server.

5. The apparatus according to claim 3, further comprising an accepting unit configured to, when accepting, from said power management server, a notification indicating that power reservation has failed as a response to the power reservation request, accept an instruction indicating whether to continue the power reservation request,
wherein if said accepting unit has accepted an instruction to continue, said request unit repetitively transfers the power reservation request until a notification indicating that power reservation has succeeded is accepted.

6. The apparatus according to claim 3, further comprising:
a unit configured to, when performing processing by using a plurality of functions of the image processing apparatus, determine whether power reservation for each of the plurality of functions has succeeded; and
an execution unit configured to execute processing by using a function of the image processing apparatus,
wherein if power reservation for all the plurality of functions has succeeded, said execution unit executes the processing by using all the plurality of functions, and
wherein if power reservation for some of the plurality of functions has succeeded, said execution unit determines a function executable for the processing at present, among the some functions, and executes the processing by using the executable function.

7. The apparatus according to claim 3, wherein for each function of the image processing apparatus, a power value necessary to use the function is defined.

8. A power management system including a plurality of image processing apparatuses, and a power management server for managing electric power for each of groups to which the plurality of image processing apparatuses belong, wherein
said image processing apparatus comprises:
an instruction unit configured to, when accepting an instruction to execute a function of the image processing apparatus, transfer, to said power management server, a power reservation request for reserving electric power necessary to use the function; and
a control unit configured to permit or restrict execution of the function in accordance with a power reservation determination result accepted as a response to the power reservation request,
said power management server comprises:
a management unit configured to manage a present electricity consumption, a reservation power value, and an upper-limiting power value for each group;
a determination unit configured to, when accepting, from the image processing apparatus, the power reservation request, determine whether to permit power reservation for the power reservation request, in a group to which the image processing apparatus belongs, in accordance with whether a total of a power value notified by the power reservation request, a reservation power value of the group, and a present electricity consumption of the group exceeds an upper-limiting power value of the group; and
a notification unit configured to notify a power reservation determination result from said determination unit as a response to the power reservation request, and
if said determination unit determines that power reservation is possible because the upper-limiting power value is not exceeded, said management unit performs power reservation by adding the power value notified by the power reservation request to the reservation power value of the group.

9. A power management method of managing electric power for each of groups to which a plurality of image processing apparatuses belong, comprising:
managing a present electricity consumption, a reservation power value, and an upper-limiting power value for each group;
determining, when accepting, from an image processing apparatus, a power reservation request for reserving electric power to be used, whether to permit power reservation for the power reservation request, in a group to which the image processing apparatus belongs, in accordance with whether a total of a power value notified by the power reservation request, a reservation power value of the group, and a present electricity consumption of the group exceeds an upper-limiting power value of the group; and
notifying a power reservation determination result from the determining step as a response to the power reservation request,
wherein if it is determined in the determining step that power reservation for the power reservation request is possible, power reservation is performed in the management step by adding the power value notified by the power reservation request to the reservation power value of the group.

10. A control method of an image processing apparatus connected to a power management server for managing electric power to be used, comprising:
transferring, when accepting an instruction to execute a function of the image processing apparatus, to the power management server, a power reservation request for reserving electric power necessary to use the function; and
permitting or restricting execution of the function in accordance with a power reservation determination result accepted as a response to the power reservation request.

11. A non-transitory computer-readable medium storing a program which causes a computer to function as:
a management unit configured to manage a present electricity consumption, a reservation power value, and an upper-limiting power value for groups to which a plurality of image processing apparatuses belong, respectively;
a determination unit configured to, when accepting, from an image processing apparatus, a power reservation request for reserving electric power to be used, determine whether to permit power reservation for the power reservation request, in a group to which the image processing apparatus belongs, in accordance with whether a total of a power value notified by the power reservation request, a reservation power value of the group, and a present electricity consumption of the group exceeds an upper-limiting power value of the group; and
a notification unit configured to notify a power reservation determination result from said determination unit as a response to the power reservation request,
wherein if said determination unit determines that power reservation for the power reservation request is possible, said management unit performs power reservation by adding the power value notified by the power reservation request to the reservation power value of the group.

12. A non-transitory computer-readable medium storing a program which causes a computer to function as:
a request unit configured to, when accepting an instruction to execute a function of the computer, transfer, to a power management server, a power reservation request for reserving electric power necessary to use the function; and
a control unit configured to permit or restrict execution of the function in accordance with a power reservation determination result accepted as a response to the power reservation request.
